(19) United States
(12) Patent Application Publication
(10) Pub. No.: US 2026/0106529 A1
(43) Pub. Date: Apr. 16, 2026

(54) INDUCTION DEVICE, IN PARTICULAR FOR AN ELECTRODYNAMIC BRAKE, AND ELECTRODYNAMIC BRAKE

(71) Applicant: Deutsches Zentrum für Luft- und Raumfahrt e.V., Köln (DE)

(72) Inventors: Christoph HOLTMANN, Sankt Augustin (DE); Christoph KÖHLER, Filderstadt (DE); Christian WEBER, Sonneberg (DE)

(73) Assignee: Deutsches Zentrum für Luft- und Raumfahrt e.V., Köln (DE)

(21) Appl. No.: 19/114,688

(22) PCT Filed: Oct. 24, 2023
(86) PCT No.: PCT/DE2023/100788

§ 371 Date: Mar. 24, 2025

(30) Foreign Application Priority Data
Oct. 25, 2022 (DE) 10 2022 128 247.3

(51) Int. Cl. H02K 49/04

(52) U.S. Cl. CPC H02K 49/046

(57) ABSTRACT

The present invention relates to an induction device (300), in particular for an electrodynamic brake (100), in which at least one support element (400) has a plurality of openings (402) and a plurality of pins (410) is divided into multiple pin clusters (416), wherein a pin cluster (416) is arranged in each opening (402). Furthermore, the invention relates to an electrodynamic brake (100).

### RELATED APPLICATION

This application is a national phase of international application No. PCT/DE2023/100788 filed on Oct. 24, 2023, and claims the benefit of German application No. 10 2022 128 247.3 filed on Oct. 25, 2022, which are incorporated herein by reference in their entirety and for all purposes.

### FIELD OF DISCLOSURE

The present invention relates to an induction device, in particular for an electrodynamic brake, and to an electrodynamic brake having this induction device.

### BACKGROUND

Eddy current brakes are known in the prior art. For example, DE 950 939 B discloses an eddy current brake, in which the pole cores of the inductor are arranged on both sides of an armature which is movable with respect to the inductor, which eddy current brake consists of one or more bodies with good electrical conductivity, which form the eddy current path, and parts with good magnetic-flux conductivity, which extend through the aforementioned body or aforementioned bodies, wherein the parts guiding the magnetic flux project beyond the body or bodies which form the eddy current path on both sides, so that the ends of these parts form projections improving the cooling of the armature.

An electrodynamic brake having a magnetic device for providing a magnetic field is known from DE 102016108646 B4, which magnetic device has at least two pole elements and cooperates with an induction device. The induction device here is arranged in such a way that, in a braking mode, it is at least partially exposed to a magnetic field provided via the pole elements of the magnetic device, and is formed in such a way that electric currents are induced in a changing magnetic field therein, wherein the induction device and the pole elements of the magnetic device are movable relative to one another along a predetermined movement path.

With the latter electrodynamic brakes and the material structure thereof, which consists of steel pins and perforated plates, it is already possible to greatly reduce the skin effect in the eddy current brake and to thereby achieve an improved current distribution. In particular, as a result of the positioning plates centering the steel pins, the surface for cooling the brake may be significantly increased and the power density may thus be enhanced.

### SUMMARY OF THE INVENTION

The object of the present invention is to propose an improved electrodynamic brake, which has an improved performance.

This object is achieved according to the invention by an induction device according to the features of claim 1 and an electrodynamic brake according to the features of claim 13. Advantageous configurations are specified in the respective, associated dependent claims.

Accordingly, the object is achieved by an induction device, in particular for an electrodynamic brake, wherein the induction device comprises at least one support element and a plurality of pins and wherein the at least one support element has a plurality of openings. The plurality of pins is divided into multiple pin clusters so that each pin cluster comprises some of the plurality of pins, wherein one of the pin clusters is arranged in each of the individual openings of the at least one support element.

The invention is based on the idea of reducing the size of individual pins and grouping multiple pins into respective pin clusters for arrangement in the individual openings of the at least one support element.

The use of comparatively small, individual pins enables the reduction in the so-called skin effect within the individual pins.

The pin clusters here enable an optimized current density at the support elements, which also function as conductive plates. A higher or optimized power density can be achieved.

At the same time, a pin fill factor or total fill factor may be maintained in this way, as opposed to when using individual pins for each opening in the support element. The overall fill factor here relates to a cross-sectional area of the arranged pins in relation to the remaining surface of the support element in a corresponding plan view.

An advantageous embodiment may consist in that the openings, and therefore the pin clusters, are distributed in a uniform grid or pattern. This grid or pattern is advantageously only interrupted or discontinued in the portions of the support element in which the full area for an opening including a sufficient adjoining web width (web area) is no longer available.

The openings are preferably incorporated perpendicularly to the support element so that a theoretical, central opening axis extends perpendicularly to the surface of the support element. The openings are ideally designed to all be identical or substantially identical.

Alternatively, the configuration of the openings may vary, preferably so that a symmetrical pattern along the surface of the individual support element is achieved. The pin clusters may therefore be designed to correspond to the respective opening.

The support element is preferably made from an electrically conductive material with a low magnetic permeability. The support elements here may ideally comprise aluminum or copper.

The pins may be advantageously made from a material with a high magnetic permeability, for example from a steel. By way of example, the type of steel provided may be a steel with the material No. 1.0718.

In one embodiment, the openings may have a circular or polygonal basic structure. A hexagonal honeycomb structure may be particularly advantageously provided as the basic structure so that the support element comprises a lattice or lattice region with hexagonal openings.

A hexagonal basic structure results in a particularly uniform distribution of the webs, web nodes or web areas surrounding the openings, so that magnetic and electrical field lines may flow particularly uniformly through the material of the support element. Moreover, a uniform flow is realized since extreme narrow points may be avoided.

Although a hexagonal basic structure is particularly advantageous, the openings may essentially also have a triangular, square or other polygonal basic structure. All in all, advantageous basic structures of the openings are those in which very uniform webs or web areas are produced as a supporting grid in order to achieve the greatest possible density and uniform distribution along the surface of the respective support element.

In an improved embodiment, it may be provided that the cluster of pins are encapsulated in the openings of at least one support element by means of an encapsulating element, preferably comprising epoxy resin or acrylic resin, In particular, the pin clusters may be encapsulated in all openings of all support elements.

The encapsulating material here should be of a type which is permanently stable at temperatures of 120° C. to 200° C. in the hardened state, in particular permanently stable at temperatures of 120° C. to 160° C. It may therefore be advantageous to use epoxy resin or an acrylic resin as the encapsulating material.

In a further improvement to this embodiment, it may be provided that the pin clusters are encapsulated in the openings of the top and the bottom support element—in particular, with three or more support elements, encapsulated exclusively in the openings of the top and the bottom support element, or the two outer support elements—by means of an encapsulating element, preferably comprising epoxy resin or acrylic resin.

As a result, optimal cooling in the inner region and in the clearances of the induction device can be achieved without disadvantages in respect of the strength and the positional stability of the pin clusters. A further improvement may consist in that the encapsulating material is poured over, or flows around, the ends of the pins of the pin clusters in the end position in the support element and the encapsulating material flows into the gap regions (interstices), at least over a partial length of the pins, and is hardened there.

In a further advantageous embodiment, an additional seal element, which is independent of the support element, is provided as a frame, lattice and/or mesh element in at least a number of the openings, through which seal element a pin cluster or the pins of a pin cluster are guided during assembly. The seal element serves, in particular, to determine the position of the individual pins of a pin cluster and as a seal for the encapsulating material in the region of the opening.

In an advantageous embodiment, the sealing element is incorporated in at least a number of the openings of a support element as a circumferential frame or as a guide for individual pins by means an additive manufacturing process.

It is essentially advantageous if the highest possible density of pins is achieved in the openings. Therefore, in an improved embodiment, it may be provided that the pins of each pin cluster have a cross-sectional area A and each individual opening of the at least one support element has a cross-sectional area B, wherein the ratio
of the total of the cross-sectional areas of all pins of an individual pin cluster to
the opening area B of the respective opening is in the region 0.85+/−0.1, advantageously in the region of 0.85+/−0.05 and, in particular, in the region of 0.85+/−0.01.

The packing density is advantageously such that the generally cylindrical pins are arranged parallel to one another and packed as closely together as possible.

Furthermore, good cooling and a good flow must be ensured so that, with high induction, the energy which is converted into heat may be conducted away. It has been shown that it may be advantageous if a circumferential web with a web width is arranged between two openings and the following ratio is produced:
the ratio of the web width to the inner radius of the opening is in the region of 0.45+/−0.15, in particular in the region of 0.45+/−0.08.

The web width here describes the smallest web width between two openings of a support element.

Analogously, one advantage may consist in that a respective circumferential web with a web width is formed between two openings of the at least one support element, wherein the ratio of half the web width to the width of the opening is in the range between 0.05 to 0.3, in particular in the range between 0.08 to 0.12. In this way, internal clearances and flow channels may be made sufficiently available for heat removal and, at the same time, a high pin occupancy may be provided.

The particular advantage of a hexagonal honeycomb structure of the openings is demonstrated here, since this gives a very uniform, stable web structure having only slightly enlarged node regions with a small area.

In a further, improved embodiment, it may be provided that the pins of a pin cluster are arranged so that they are in abutting contact with one another over at least a partial length along the longitudinal extent; in particular, each pin of a pin cluster is arranged so that it is in contact with least three adjacent pins along at least a partial length.

In a further improved embodiment, it may be provided that at least a number of the outer pins of a pin cluster are in abutting contact with the support element.

This means that the outer pins are in abutting contact with one of the opening edges of the opening so that support may be provided thereby. In the case of a cylindrical pin and a linear opening edge, the two geometries are tangent to one another along a contact line.

To avoid short circuits and for optimal formation of magnetic field lines, a further improvement may consist in that at least a number of the pins have an electrically insulating material on their outer surface. This may be an additive coating, such as a phosphate coating, or another electrically insulating coating.

For the subsequent installation of the induction device with a magnetic device on one side, an improved embodiment may consist in that a return element is provided, which is preferably manufactured from a magnetically soft composite or from a ceramic ferrite and is, in particular, formed as an iron-containing return element.

This return element may form a termination element and is in the form of a plate or ring, for example.

In particular, the return element may be in touching contact with one longitudinal end of the pins or the pin clusters.

In the installed state, the return element is preferably arranged on the side of the induction device which is remote from the poles or pole shoes. The return element is formed parallel to the support elements.

The pins or the pin clusters may be encapsulated in or on the return element.

In the context of the present invention, various return and/or exciter variants may, in particular, be provided, such as those known, for example, from DE 10 2016 108 646 B4.

For example, a disk-shaped return element may be provided or a helically wound steel strip for forming a disk-shaped return element.

Furthermore, the exciter coils or pole elements may be arranged, for example, on one side of the induction device or, by replacing the return element, on both sides of the induction device. The exciter coils or pole elements here may be formed exclusive as north poles, or at least some of the pole elements may be provided in the form of permanent magnets instead of as coils wound around a core. In particular, in the event that pole elements are arranged on both sides, north poles or south poles may each be arranged exclusively on one side of the respective carrier plate.

In the context of the present invention, the pole elements may be provided, in particular, as a rotor, wherein the induction device may be provided as a stator.

In a further improved embodiment, it may be provided that at least one spacer, in particular in the form of a silicone cord, a plastic cord, a silicone ring, a plastic ring or the like, is arranged between two adjacently arranged support elements of the multiplicity of support elements, so that a minimum spacing between two adjacently arranged support elements is provided.

To this end, one or more flexible spacers may be arranged between two support elements, for example one or more silicone cords. In particular, silicone or plastic rings may also be placed around a multiplicity of pin clusters against which a subsequent support element lies or abuts. The support elements arranged one above another advantageously provide an open, flow-enabling structure.

According to a further advantageous embodiment of the invention, the induction device may have at least one cover element, in particular at least one cover plate, wherein the at least one cover element is provided opposite and/or in the region of a longitudinal end of the plurality of pins and the cover element has an electrical conductivity which is lower than the electrical conductivity of the at least one support element.

By way of example, the cover element may comprise a material such as stainless steel or the like.

Furthermore, the cover element or the cover plate may preferably be arranged in contact with the encapsulating element.

In particular, the cover element may be provided on a side of the induction device which is opposite the return element.

If pole elements or coils are provided on both sides of the induction device, the induction device may be formed with two cover elements, wherein one cover element in each case is arranged on or in the region of one of the longitudinal ends of the plurality of pins, preferably abutting against the respective encapsulating element or encapsulating material.

The cover element preferably has the lowest possible electrical conductivity.

As a result of the cover element having a low electrical conductivity, the encapsulating element, for example an epoxy resin, may be protected against significant or excessive heat input.

The invention furthermore comprises an electrodynamic brake, which has a magnetic device for providing a magnetic field. The magnetic device preferably has at least one pole element and an induction device according to the present invention.

The induction device may preferably be arranged in such a way that, in a force mode, it is at least partially exposed to a magnetic field provided via the pole elements of the magnetic device, wherein the induction device and the pole elements of the magnetic device are movable relative to one another along a predetermined movement path.

Further details and advantages of the invention shall now be explained in more detail with reference to exemplary embodiments illustrated in the drawings.

### BRIEF DESCRIPTION OF THE DRAWINGS

FIG. 1 shows a perspective view of an exemplary embodiment of the induction device in a first partial illustration I. and an enlarged detail in a second partial illustration II;

FIG. 2 shows a sectional illustration of an exemplary embodiment of the induction device in a perspective view;

FIG. 3 shows a perspective view of an exemplary embodiment of the induction device in a partially manufactured state;

FIG. 4 shows a perspective view of an exemplary embodiment of the induction device with encapsulated pin clusters;

FIG. 5 shows a perspective illustration of an exemplary embodiment of the electrodynamic brake in partial section.

### DETAILED DESCRIPTION OF THE DRAWINGS

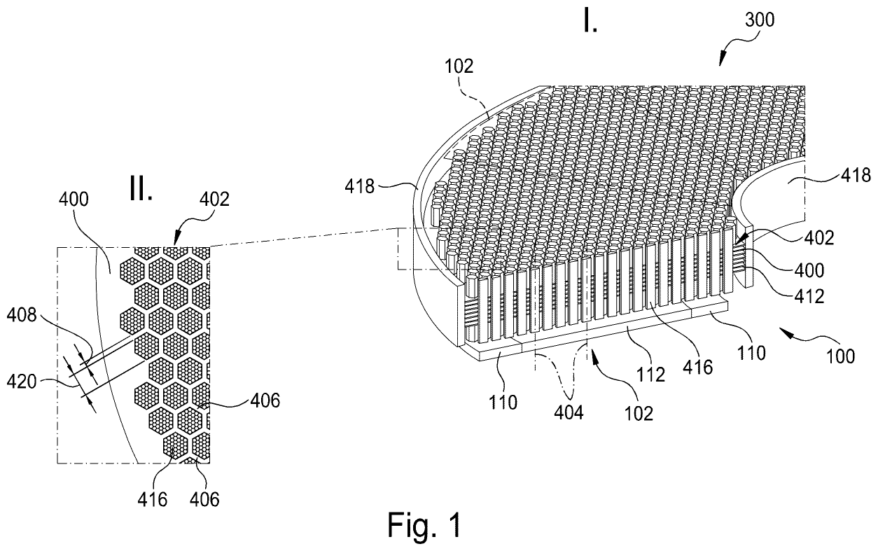

FIG. 1 shows an exemplary embodiment of an induction device 300 for an electrodynamic brake 100.

According to FIG. 1, the induction device 300 may have seven horizontal support elements 400, each having a plurality of openings 402.

A cluster of pins 410 forming a pin cluster 416 is respectively arranged in each opening 402.

In the partial image I., the pin clusters 416, each having a multiplicity of pins 410, are each illustrated in schematically simplified form as a cylinder.

The pin clusters 416 penetrate all seven support elements 400.

According to FIG. 1, longitudinal axes of the pin clusters 416 are arranged congruently or coaxially with the opening axis 404 of the respective opening 402.

A wall element 418 (illustrated in simplified form) is arranged on the inside and outside of the induction device 300, which wall element is part of the electrodynamic brake 100 and delimits the induction device 300 on both sides of the narrow sides.

A multiplicity of pole elements 102, of which pole elements 102 are indicated below the induction device 300 in FIG. 1, may be arranged along at least one wide side of the induction device 300.

The pole elements 102 have a ferrite core and an exciter coil 110 extending around the core 112.

The exciter coil 110 may be energized by a current source (not illustrated) in a manner controlled and/or regulated by a control unit (likewise not illustrated).

In normal operation of the induction device 300 shown, or the electrodynamic brake 100, the induction device 300 is rotatably mounted via a shaft (not illustrated) and the energized pole elements 102 are stationary.

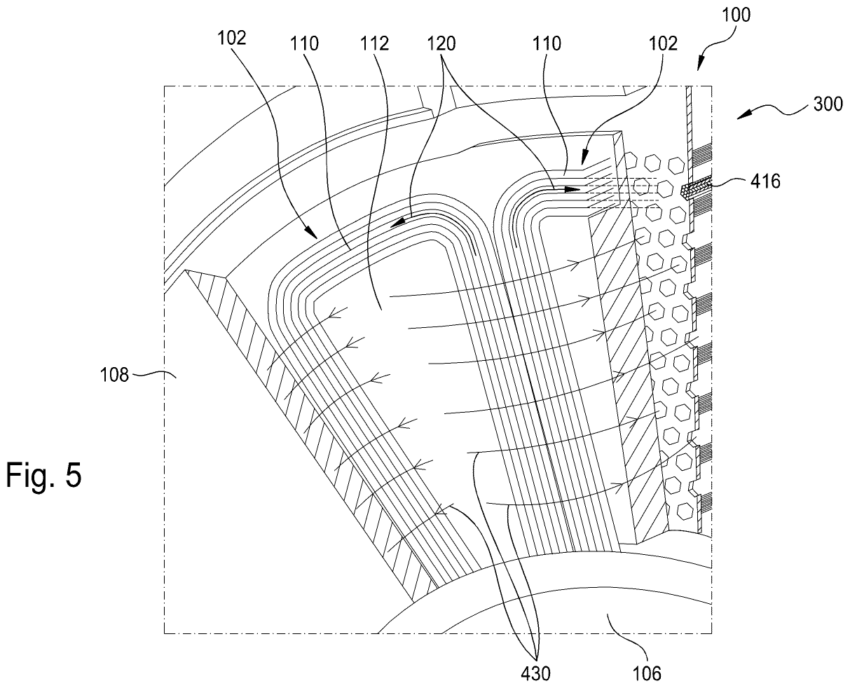

A force transmission and negative acceleration of the induction device 300 may take place if the coils 110 of the pole elements 102 are energized and act on the induction device 300, as also described and illustrated in detail, in particular in FIG. 5.

In the partial illustration Il of FIG. 1, the hexagonal basic structure of the openings 402 is illustrated in detail as a plan view of a detail of the induction device 300.

A honeycomb-like grid pattern of the webs 406 is produced by the plurality of hexagonal openings 402.

A pin cluster 416 is arranged in each opening 402, which pin cluster is in flush alignment with the opening axis 404.

By way of example, the narrow width 420 of the opening 402 may be 6.3 mm and may therefore have an opening area of 31.17 mm².

In the example shown according to the partial image II. of FIG. 1, a pin cluster 416 comprises a total of 37 individual pins 410.

By way of example, the pins 410 may each have a pin width 422 or diameter of 1 mm and, in total, may therefore occupy an area of 29.06 mm² in the opening.

Furthermore, the web width 408 outside the node areas may be 1.38 mm. This results in a theoretical occupiable area of 38.37 mm², which is calculated from the above-mentioned opening area plus half the web area around the respective opening 402.

The example realized above gives an occupancy of 0.964 pins per mm² area of the support element 400.

In particular, an occupancy of up to 0.98 may be achieved if the web width 408 is further reduced.

For a uniform non-clustered arrangement of individual pins 410, such an occupancy could only be realized with significant effort, if at all.

Furthermore, a sufficient web width 408 may be ensured despite the high occupancy. Sufficient heat removal via support elements 400 may be ensured during the operation of the induction device 300.

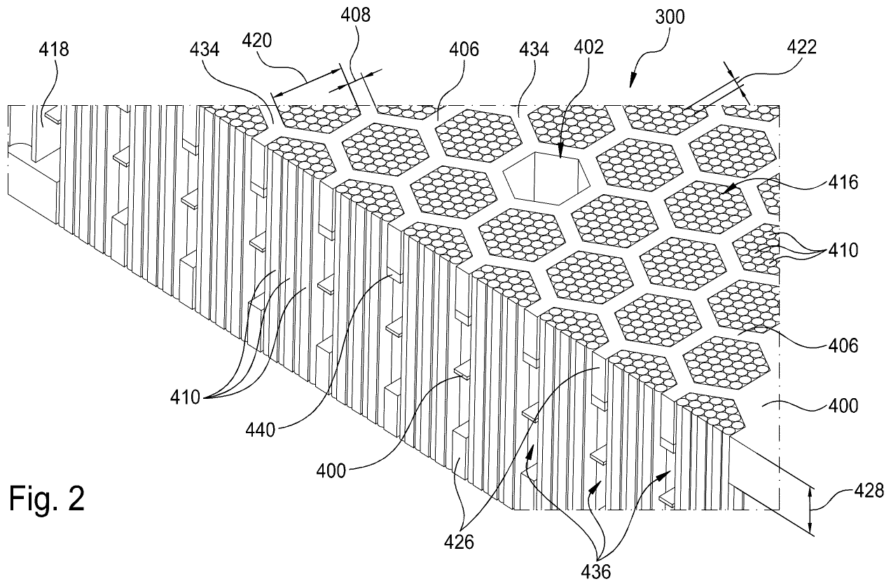

In FIG. 2, a further embodiment of an arrangement of an induction device 300 is shown as an enlargement in a vertical section in a perspective view.

The adjacent wall element 418 is arranged on the left edge in the image in FIG. 2.

By way of example, the opening width 420 of the hexagonal openings 402 may be 6.3 mm, the web width 408 may be 1.38 mm and the diameter 422 of an individual pin 410 may be 1.0 mm.

In FIG. 2, an individual opening 402 is shown without a pin cluster 416 for illustrative purposes.

The support element 400 may have a material thickness 428 of 4 mm, for example, and may comprise, in particular, a material such as aluminum.

A plurality of support elements 400 may be arranged between the two encapsulating elements or encapsulating resins 426. Furthermore, at least one cover element or a cover plate 440 may be provided, which is preferably arranged in the region of a longitudinal end of the plurality of pins 410. A structure through which a coolant can flow is formed with the aid of flow channels 436 between the individual pin clusters 416 and the support elements 400 (c.f. also clearances 412 according to FIG. 1).

All in all, it should be understood that the information relative to gravity, such as “up”, “down”, “to lower”, “seated”, “upright”, “suspended” etc. serve merely for illustrative purposes and to describe the elements illustrated in a specific position. This information should not be understood as being restrictive in respect of the alignment of the induction device when in use or during assembly and is also similarly provided for a different alignment, such as a vertical alignment of the induction device.

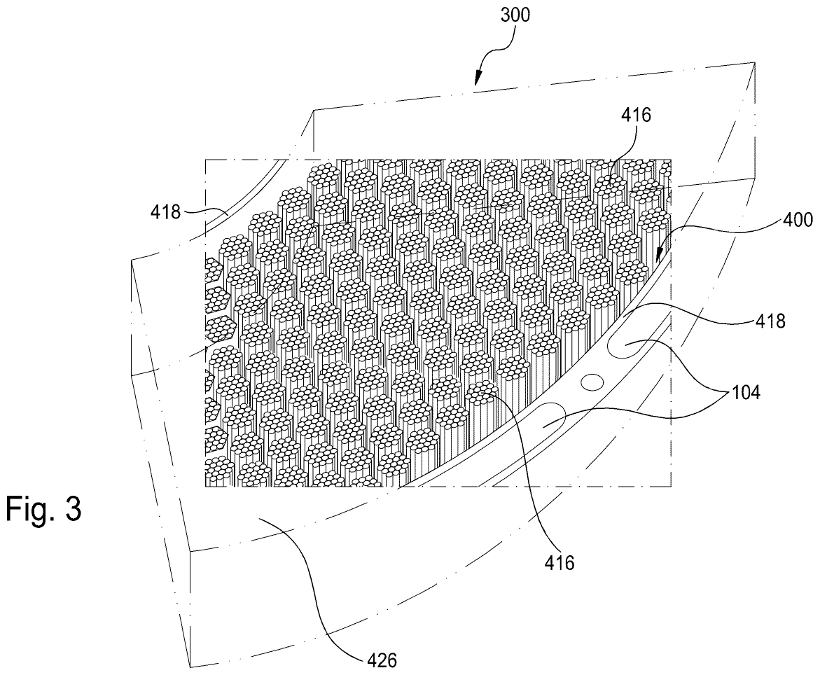

FIG. 3 shows the pin clusters 416 according to an exemplary embodiment, which pin clusters are positioned in the bottom support element 400 and aligned perpendicularly thereto.

A wall element 418 is arranged on the left and right of the induction device 300, wherein cooling channels 104 are provided in the radially outer wall element 418 illustrated on the right.

According to FIG. 3, the main geometry 424 of the induction device 300 may be a ring or annulus.

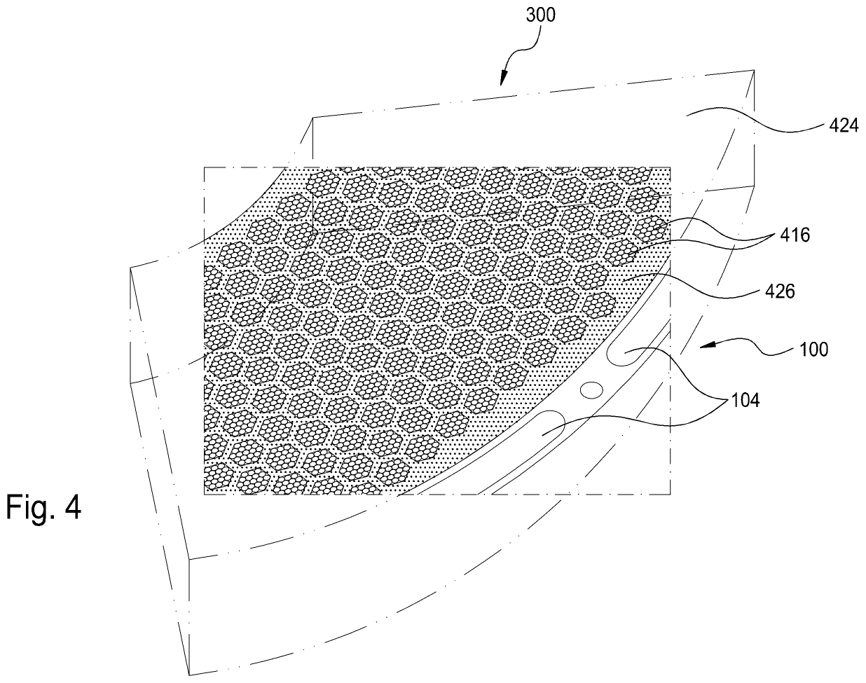

In FIG. 3, the induction device 300 is illustrated in a manufacturing step before completion. In particular, according to FIG. 3, (at least) one upper support element 400 may be lowered onto the illustrated pin clusters 416 for completion, which support element, as illustrated in FIG. 4, may then be encapsulated with the ends of the pin clusters 416 by means of an encapsulating element/resin, preferably epoxy resin or acrylic resin.

FIG. 4 shows the induction device 300 according to FIG. 3 after a support element 400 (not visible) has been encapsulated with the pin clusters 416 by means of an encapsulating element/encapsulating resin 426.

This is poured over the spaces above the webs 406 and the web nodes 434 and hardened. In addition, it is possible that the encapsulating resin 426 is poured over the free ends of the pins 410 of the pin clusters 416 so that it may also penetrate a certain distance into the interstices between the individual pins 410 and harden there.

In FIG. 5, the electrodynamic brake 100 is shown in the released state in partial section. The induction device 300 is fixed to the schematically illustrated shaft 106 and represents the component to be braked.

Pole elements 102 (illustrated in a parallel section) are arranged and fastened on a carrier plate 108 (shown in front) which does not rotate with the shaft 106 and is stationary.

The pole elements 102 each have a core 112 with a radially outer wider side and a radially inner narrower side, so that these are designed similarly to a ring segment.

A multi-layer exciter coil 110 is arranged around the cores 112 in each case, which exciter coil may be activated in a manner not illustrated in more detail and may have a current flowing through it.

The induction device 400 is designed similarly to the embodiments above; i.e. it has a plurality of pin clusters 416.

Current flows through the adjacently and parallel extending limbs of the exciter coils 102 of adjacent pole elements 102 with the same current direction 120, i.e. radially outwards in the example for the two parallel limbs.

Therefore, in the exemplary embodiment shown in FIG. 5, magnetic field lines 430 form, which exit out of the viewing plane in the case of the core 112 on the left and enter into the core 112 on the right (which is illustrated in section).

In parallel with this, the pins 410 are acted upon electrodynamically in a known manner, as described, for example, in DE 10 2016 108 646 B4, so that braking of the induction device 400 occurs.

In the example shown, the pole elements 102 are arranged on both sides of the wide side of the induction device 300. Alternatively, the formation of the magnetic field may be ensured via an iron-containing or ferrite return element.

### List of Reference Signs

100 Brake
102 Pole element
104 Cooling channel
106 Shaft
108 Carrier plate
110 Exciter coil
112 Core
120 Current direction
300 Induction device
400 Support element
402 Opening
404 Opening axis
406 Web
408 Web width
410 Pin
412 Clearance
416 Pin cluster
418 Wall element
420 Width
422 Web width
424 Main geometry
426 Encapsulating resin/encapsulating element
428 Material thickness
430 Field lines, magnetic
434 Web nodes
436 Flow channels
440 Cover element/cover plate
A Cross section
B Opening area

1. An induction device optionally for an electrodynamic brake, wherein the induction device comprises at least one support element and a plurality of pins,
the at least one support element has a plurality of openings,
wherein the plurality of pins is divided into multiple pin clusters so that each pin cluster comprises some of the plurality of pins, and
wherein one of the pin clusters is arranged in each of the individual openings of the at least one support element.

2. The induction device as claimed in claim 1,
wherein
the openings have a circular or a polygonal basic structure and, optionally, have a hexagonal honeycomb structure as the basic structure.

3. The induction device as claimed in claim 1,
wherein
the clusters of pins are encapsulated in the openings of at least one support element optionally, encapsulated in all openings of all support elements by means of an encapsulating element, preferably epoxy resin.

4. The induction device as claimed in claim 1,
wherein the pin clusters are encapsulated in the openings of the top and the bottom support element optionally, with three or more support elements, encapsulated exclusively in the openings of the top and the bottom support element by means of an encapsulating element, preferably epoxy resin.

5. The induction device as claimed in claim 1, wherein
the pins of each pin cluster have a cross-sectional area A and each individual opening of the at least one support element has a cross-sectional area B, wherein the ratio
of the total of the cross-sectional areas A of all pins of an individual pin cluster to
the opening area B of the respective opening is in the region of 0.85+/−0.1, optionally in the region of 0.85+/−0.05.

6. The induction device as claimed in claim 1, wherein
a respective circumferential web with a web width is formed between two openings of the at least one support element, wherein the ratio of half the web width to the width of the opening is in the range between 0.05 to 0.3.

7. The induction device as claimed in claim 1, wherein the pins of a pin cluster are arranged so that they are in abutting contact with one another over at least a partial length along the longitudinal extent; optionally, each pin of a pin cluster is arranged so that it is in contact with least three adjacent pins along at least a partial length.

8. The induction device as claimed in claim 1, wherein
at least a number of the outer pins of a pin cluster are in abutting contact with the support element.

9. The induction device as claimed in claim 1, wherein
at least a number of the pins have an electrically insulating material as an additive coating or are covered with a coating, optionally have a phosphate-containing material as an additive coating.

10. The induction device as claimed in claim 1, wherein
a return element is provided, which is preferably manufactured from a magnetically soft composite or from a ceramic ferrite, optionally an iron-containing return element.

11. The induction device as claimed in claim 1, wherein
at least one spacer, optionally in the form of a silicone cord, a plastic cord, a silicone ring, a plastic ring or the like, is arranged between two adjacently arranged support elements of the multiplicity of support elements, so that a minimum spacing between two adjacently arranged support elements is provided.

12. The induction device as claimed in claim 1, wherein
the induction device has at least one cover element, optionally at least one cover plate, which is provided opposite and/or in the region of a longitudinal end of the plurality of pins, wherein the cover element has an electrical conductivity which is lower than the electrical conductivity of the at least one support element.

13. An electrodynamic brake, having a magnetic device for providing a magnetic field, which has at least one pole element and an induction device as claimed in claim 1.
